(19) United States
(12) Patent Application Publication
(10) Pub. No.: US 2025/0325850 A1
(43) Pub. Date: Oct. 23, 2025

(54) Harness

(71) Applicant: SKYLOTEC GmbH, Neuwied (DE)

(72) Inventors: Ursula Oberrauch, Villa D’Adda (IT); Brioschi Gianluca, Gorgonzola (IT); Mattia Spada, Lecco (IT)

(21) Appl. No.: 19/184,141

(22) Filed: Apr. 21, 2025

(30) Foreign Application Priority Data
Apr. 22, 2024 (EP) 24 171 716.4

(51) Int. Cl. A62B 35/00

(52) U.S. Cl. CPC A62B 35/0018; A62B 35/0031; A62B 35/0037

(57) ABSTRACT

A harness includes a belt loop, a chest loop, at least one chest loop connection element, at least one chest connection belt, each having a first chest loop connection end and an opposite second chest loop connection end, and a belay connection element, wherein the belt loop and the chest loop are connected to one another via the belay connection element, each first chest loop connection end and the chest loop are connected to one another, and the belt loop and the belay connection element are configured for alternatively and detachably connecting with the respective second chest loop connection end via the respective at least one chest loop connection element.

### CROSS-REFERENCE TO RELATED APPLICATIONS

The present application is based upon and claims the right of priority to EP Patent Application No. 24 171 716.4, filed Apr. 22, 2024, the disclosure of which is hereby incorporated by reference herein in its entirety for all purposes.

### FIELD OF INVENTION

The invention relates to a harness including a belt loop, a chest loop and a belay connection element, wherein the belt loop and the chest loop are connected to one another via the belay connection element. The invention further relates to a method for putting on a harness including a belt loop, a chest loop and a belay connection element, wherein the belt loop and the chest loop are connected to one another via the belay connection element.

### BACKGROUND

A part of safety equipment is designated as a harness, which is worn on a body of a person during climbing, ski touring, mountaineering, via ferrata, tree maintenance, or during work with a risk of falling, and through which a connection is established between the person to be secured and, for example, a safety device to prevent falls or a tie in point.

The harness is generally made from several loops, which are placed around the middle of the body as belt loop respectively hip belt and around a chest of the person as chest belt. The loops are brought together at a tie in point, often provided as belay connection element, to which a safety rope or a carabiner may be connected as a safety device against falling. The hip belt, the chest belt, and an optionally present leg belt are adjustable to the bodily dimensions of the person to be secured, so that on the one hand forces occurring between the person and the harness are safely transmitted and, on the other hand, it may be prevented that the person to be secured unintentionally slips out of the harness. Harnesses for climbing in the recreation sector and for industrial safety are basically comparable in structure; however, said harnesses must satisfy different standards. While standard EN 12277 is relevant, for example, in the sporting sector, standard EN 361 applies for harnesses for industrial safety and standard EN 358 applies for tethers.

Harnesses known from prior art are usually designated for a specific use. For example, harnesses designated for climbing can theoretically be used for ski touring, however, harnesses designated for ski touring allow, for example, a greater freedom of movement. On the other hand, a person using the harness often wants to combine said activities i.e. may be forced to change the harness during an activity, for example taking off the ski touring harness for putting on the climbing harness. Such change, however, is impractical and also requires that two different harnesses are carried with.

### SUMMARY OF SOME EMBODIMENTS OF THE INVENTION

It is an object of the invention to provide a harness and a respective method for putting on a harness which can be equally used for different application scenarios, for example both for ski touring and climbing.

The object is solved by the features of the independent claims. Preferred embodiments are described by the features of the dependent claims.

Thus, the object is solved by a harness including a belt loop, a chest loop, at least one chest loop connection element, at least one chest connection belt, each having a first chest loop connection end and an opposite second chest loop connection end, and a belay connection element, wherein
the belt loop and the chest loop are connected to one another via the belay connection element,
each first chest loop connection end and the chest loop are connected to one another, and
the belt loop and the belay connection element are configured for alternatively and detachably connecting with the respective second chest loop connection end via the respective at least one chest loop connection element.

It is therefore a key point of the invention to provide a harness which allows for a simple transition from one configuration to another, thereby changing an intended use and affinity of the harness. The proposed harness is thus perfectly applicable for activities where different body positions are required during use, for example from standing on a roof to sitting in the harness for climbing a ladder. The harness thus allows changing its configuration, for example, from a lighter fit during walking, to more support while descending. Furthermore, the harness allows putting on without lifting feet from ground, which is in particular advantageous for soldiers or for a person on a via ferrata i.e. a fixed-rope route. Specifically, when the second chest loop connection ends are connected to belt loop, the harness allows easier climbing, as chests are attached lower to the harness compared to the other configuration. When the second chest loop connection ends are connected to the belay connection element, the harness allows easier walking, hiking, trekking or ski touring, as chests are attached higher to the harness.

In other words, the proposed harness is able to modify its load bearing structure while fitted to a user wearing the harness. In particular, the belt loop, which can also be referred to as hip loop, provides for a load distribution along a main structure i.e. the hip of the person so that no interruption of a safety chain occurs when changing the connection of the second chest loop connection end with respectively between the belt loop and the belay connection element. In other words, said two configurations can be changed without exiting the harness. On the other hand, the changeable second chest loop connection end provides a configurable load bearing structure which can be configured respectively set by the user wearing the harness according to a foreseen activity immediately before starting the activity and without undressing. The at least one chest loop connection element allows for an easy change between the two configurations.

The harness can be used for different indoor and outdoor activities, such as for example climbing, mountaineering, walking, hiking, military purposes, ski touring, via ferrata, tree maintenance, or during professional work activities. The belt loop can also be referred to as hip loop and/or is preferably intended and/or sized for being put around the hip of the person wearing the harness. Equally, the chest loop and/or the belt loop is preferably intended and/or sized for being put around the belt and/or chest of the person wearing the harness. The harness can be combined with leg loops attachable to the belt loop and/or belay connection element.

The belay connection element can be provided as rounded and/or closed belt or strap, which can be worn and/or is textile, for example having a diameter between 5 and 10 cm, and/or as a carabiner, as a metal ring and/or a mixture thereof. The belay connection element is intended to connect the harness with a carabiner, a safety device, a lanyard or the like. In this respect to term connected to one another means preferably that, for example, the belay connection element is fed or passed through the belt loop, preferably in a firmly manner allowing a degree of flexibility between the belay connection element and the belt loop. Generally, the harness is preferably made of textile materials, such as webbings, belts, straps, or the like. The at least one chest loop connection element is preferably configured for providing the alternative and detachably connection between the belay connection element and the belt loop. The harness preferably includes an overall weight of ≤200 g, ≤160 g, ≤140 g or ≤100 g.

According to a preferred implementation the at least one chest loop connection element is provided as buckle, in particular as side release buckle or as alamari, as hook, as knot and/or as carabiner with respective eyelet. The buckle can be provided as plastic and/or a metal buckle. One part of the buckle can be firmly attached to the belt loop and/or the belay connection element, while another part of the buckle can be firmly attached to the second chest loop connection end, for example by sewing. The hook and/or the carabiner can equally consist of plastic and/or metal. The eyelet is preferably provided as loop made of a folded strap and/or webbing, which is sewn, for example, onto respectably with the belt loop.

Alamari, also referred to a frog fastener and/or used in nautical devices, is basically a button acting as fastener when inserted into an eyelet. The button can be attached to an end of a strap and/or webbing, while extending perpendicular to an extension of the strap and/or webbing. The alamari can be equipped with a flexible cord, such as a rubber cord or an elastic rope, which can be wound around the alamari and the eyelet when the alamari is inserted into the eyelet for securing the alamari with the eyelet. Alternatively, the at least one chest loop connection element can be provided as simple knot.

In another preferred implementation the at least one chest loop connection element includes an eyelet attached to the belt loop and/or to the belay connection element end for connecting with the respective second chest loop connection end. The belt loop may include a plurality of eyelets, for example three eyelets arranged ones besides each other, and/or arranged close to the belay connection element, for example 5 cm close to the belay connection element, or arranged opposite to the belay connection element. Similarly, the eyelet attached to the belay connection element may be arranged close to chest loop, for example directly adjacent to the chest loop.

According to a further preferred implementation the respective first chest loop connection end is connected to a backside of the chest loop and the belay connection element is connected to an opposite frontside of the chest loop. The first chest loop connection end is preferably firmly connected or slidably movable connected along the chest loop, for example by sewing or by means of a loop formed by the first chest loop connection end. The belay connection element preferably connected with a belay connection loop of the chest loop formed at the frontside of the chest loop.

In another preferred implementation the belay connection element is connected to a frontside of the belt loop and the belt loop is configured for being connected on an opposite backside via the respective at least one chest loop connection element. Such way the belt loop can be connected on its backside with the second chest loop end, for example at a defined position.

According to a further preferred implementation, two first chest loop connection ends are distantly connected of the chest loop. Preferably, the two first chest loop connection ends are connected 10, 15 or 20 cm distant to each other. The two first chest loop connection ends can be firmly connected to the chest loop, for example by sewing. Alternatively, the two first chest loop connection ends can be flexibly connected to the chest loop, for example by a loop wound around the chest loop. Such way the first chest loop connection ends can be adjusted in respect to their distance to each other.

In another preferred implementation the harness includes two shoulder belts, which are preferably distantly connected with respective opposite ends to a backside and a frontside of the chest loop. Such way one of the shoulder belts is intended to be worn around one shoulder of the person wearing the harness, while another one of the shoulder belts is intended to be worn around another shoulder of the person wearing the harness. Said opposite ends can be firmly sewed with the chest loop and/or connected via shoulder belt buckles, thereby allowing an adjustment of a length of the respective shoulder belt.

According to a further preferred implementation, the shoulder belt is provided one-piece with one of the at least one chest connection belt. Preferably an interconnecting part of the shoulder belt and the chest connection belt is firmly connected and/or sewn with the chest loop, preferably at the backside of the chest loop and/or distant to each other. More preferably the shoulder belt and/or the chest connection belt extend orthogonal to the chest belt.

According to a preferred implementation the belt loop includes a belt loop connection area for connecting the belay connection element. Said belt loop connection area is preferably surrounded by a belt loop connection webbing. The belt loop connection webbing is preferably sewed to the belt loop and/or is intended for connecting with the belay connection element. Such belt loop connection webbing may prevent abrasion between the chest loop connection area and the belay connection element.

In another preferred implementation the belt loop connection area is provided as belt connection loop connecting the belay connection element. Such belt connection loop may advantageously hold the belay connection element in its position. According to a preferred implementation the belt loop connection area includes a belt loop connection buckle, in particular a side release buckle, for forming the belt connection loop. The belt loop connection buckle is preferably arranged in parallel to the belt loop connection webbing and/or sewed with the belt loop. By opening and closing the belt loop connection buckle the belay connection element can be connected to the belt loop. Such belt loop connection buckle allows for putting on the harness without removing feet from ground, for example during a ski touring activity.

In another preferred implementation the chest loop includes a first chest loop end, an opposite second belt loop end and a chest loop connector for detachably connecting the first chest loop end and the second chest loop end. According to a preferred implementation the chest loop connector is provided as chest loop buckle, in particular as sliding chest loop buckle. Such way the chest loop can be attached around the chest of the person and thereafter fastened by the chest loop buckle to the person.

According to a further preferred implementation the belt loop, the at least one chest connection belt, the belay connection element and/or the two chest loops are provided as flat webbing. The webbing can be provided from a textile material, for example made from sailcloth, by thereby advantageously minimizing weight of the harness. The webbing preferably includes convex isosceles trapezoid like shape with rounded edges. The webbing can be bordered at its both longitudinal edges by a respective folded ribbon, in particular a textile ribbon. Said ribbons are preferably sewed to the flat webbing and/or at its opposite ends, such wise forming, for example the first chest loop connection end and the opposite second belt loop end.

In another preferred implementation the harness includes two leg loops, which are preferably distantly connected to the belay connection element. Said leg loops are intended for being worn by the person around the respective legs and/or can be connectable to the belay connection element by leg belts, leg straps, leg buckles or a combination thereof.

The object is further solved by a method for putting on a harness including a belt loop, a chest loop, at least one chest loop connection element, at least one chest connection belt, each having a first chest loop connection end and an opposite second chest loop connection end, and a belay connection element, wherein
each first chest loop connection end and the chest loop are connected to one another, and including the steps of:
Connecting the belt loop and the chest loop via the belay connection element together, and
Detachably connecting each second chest loop connection end via the respective at least one chest loop connection element alternatively to the belt loop or to the belay connection element.

Thereby, connecting the belt loop and the chest loop via the belay connection element can be achieved by closing a belay connection element buckle after having inserted the belt loop and the chest loop into the belay connection element. Similarly, connecting the second chest loop connection end alternatively to the belt loop or the belay connection element end can be achieved by inserting the respective alamari into the respective eyelet. Such method allows for changing the respective configuration of the harness while wearing the harness, for example when changing the activity.

Further advantages and embodiments of the method can be derived from the harness as described before.

Other example embodiments of the invention will be described in the following with reference to the figures. It has to be noted that the figures are only provided for illustration of the general concept of the invention by examples not defining the scope of protection of the invention. The figures are not drawn to scale. Features shall not be considered to be essential for the present invention because they are depicted in the figures.

### BRIEF DESCRIPTION OF THE FIGURES

In the figures

FIG. 1 shows an exemplary embodiment according to the invention in a schematic view, and

FIG. 2 shows a further exemplary embodiment according to the invention in a schematic frontside view, and

FIG. 3 shows the further exemplary embodiment according to the invention in a schematic backside view.

### DETAILED DESCRIPTION OF THE FIGURES

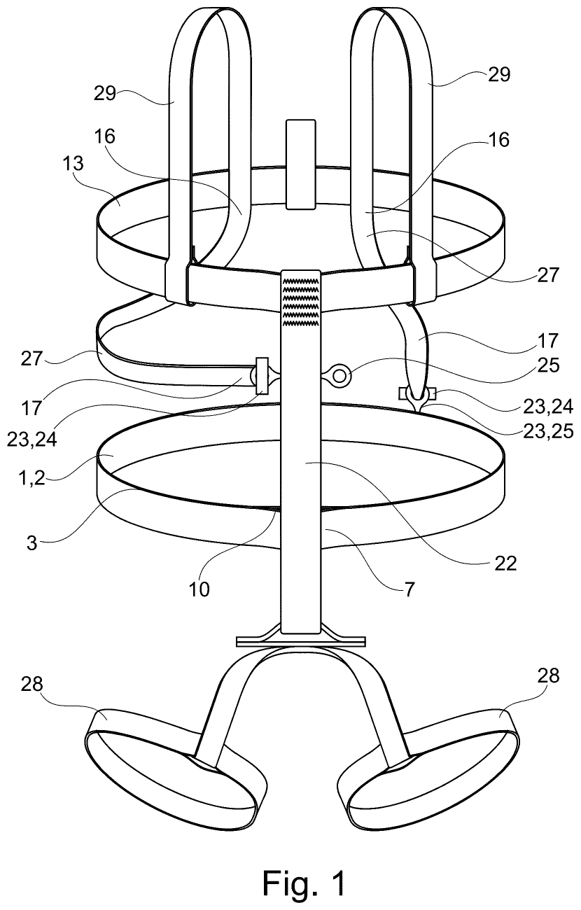

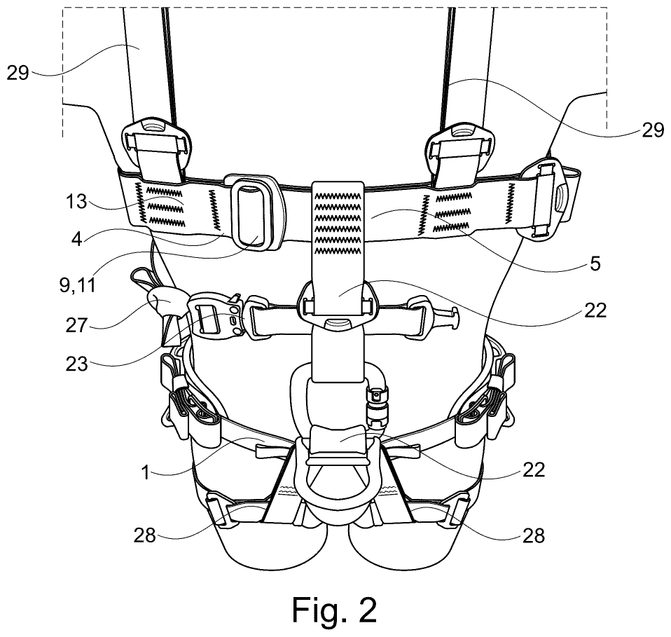

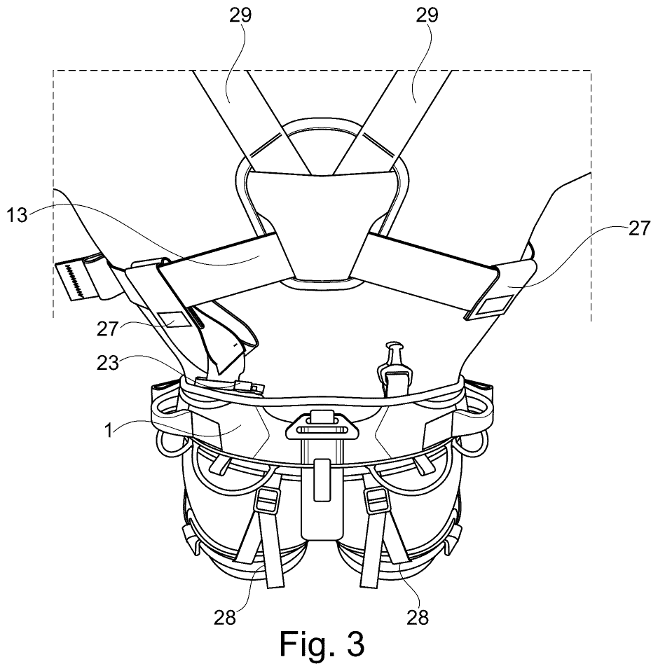

The invention will be described in the following with reference to an exemplary embodiment showing in FIG. 1 a harness in a schematic view and worn by a dummy in FIG. 2 from a frontside and FIG. 3 from a backside.

The harness includes a belt loop 1, which is configured for being worn by the person around a hip and/or belt. The belt loop 1 is provided as flat textile webbing 2 which may have a convex isosceles trapezoid like shape with rounded edges. The flat webbing 2 can be bordered at its both longitudinal edges by a respective folded ribbon 3, which are sewed to the flat webbing 2. A belt loop connection area 7, which can be surrounded by a belt loop connection webbing, is provided at a frontside of the belt loop 1 and forms a belt connection loop 10, which is connected to a belay connection element 22.

The harness further includes two leg loops 28, which, similar as the belt loop 1, are each provided as flat textile leg webbing and may also have a convex isosceles trapezoid like shape with rounded edges. The flat leg webbing can equally be bordered at its both longitudinal edges by a respective folded leg ribbon, which are sewed to the flat chest webbing. Each leg loop 28 is connected via a strip to the belay connection element 22 made of a sewed belt.

The harness further includes a chest loop 13 and two chest connection belts 27. Each chest connection belt 27 has a first chest loop end 16 and an opposite second chest loop end 17. The belay connection element 22 connects the belt loop 1 with the chest loop 13 which is such wise, when worn by the person, distantly arranged above the belt loop 1. The belay connection element 22 may be a closed or a closeable loop, or may include a carabiner for connecting two belay connection element parts, of which one part connects to the belt loop 1 and the other part connects the chest loop 13. The chest loop 13 includes a first chest loop end 4, an opposite second belt loop end 5 and a chest loop connector 11 for detachably connecting the first chest loop end 4 and the second chest loop end 5. The chest loop connector 11 is provided as chest loop connection buckle 9, in particular as sliding chest loop buckle.

Each first chest loop end 16 and the chest loop 13 are connected to one another at a backside of the chest loop 13. The first chest loop ends 16 can be sewed with the chest loop 13 in an orthogonal manner such that the chest connection belts 27 extend downwards from the chest loop 13 towards the belt loop 1. The first chest loop ends 16 can also be attached in a sliding manner to the chest loop 13 such that a position of the first chest loop ends 16 relative to each other can be adjusted.

The respective second chest loop ends 17 can be alternatively and detachably connected via a respective chest loop connection element 23 to a backside of the belt loop 1 or to the belay connection element 22. As can be seen from FIG. 1, the two chest loop connection elements 23 are provided as alamaris 24 and respective corresponding eyelets 25 into which the alamaris 24. Both second belt loop ends 17 are equipped with a respective alamaris 24. Both the belt loop 1 and the belay connection element 22 are provided with a respective eyelet 25, into which the alamaris 24 can be inserted and respectively connected with. Said alamaris 24 are provided with a retainer provided as elastic band, which can be wound around the alamari 24 for such wise securing the alamari 24 inserted into the eyelet 25.

Such wise the belt loop 1 and the belay connection element 22 can be alternatively and detachably connected with the respective second belt loop ends 17 via the respective chest loop connection element 23, namely by inserting the respective alamaris 24 in the respective eyelet 25. As can be seen from FIG. 1, the left chest connection belt 27 respectively the alamaris 24 of respectively connected to the second belt loop end 17 of the left chest connection belt 27 is inserted into the eyelet 25 attached to the belay connection element 22, wherein the right chest loop connection belt 27 respectively the alamaris 24 of respectively connected to the second belt loop end 17 of the right chest connection belt 27 is inserted into the eyelet 25 attached to the belt loop 1.

As shown in FIGS. 2 and 3, the loop connection elements 23 can alternatively be provided as buckles, in particular as side release buckles, or, as not shown, as hooks and/or carabiner with corresponding eyelets 25. Said Figs. show a two-part belay connection element 22, which in is interconnected by a carabiner. While FIG. 1 shows two shoulder belts 29 being distantly connected with respective opposite ends both to a backside and a frontside of the chest loop 13, FIG. 3 shows that the ends on the backside are jointly connected to the chest loop 13, while the ends on the frontside are distantly connected. Also, while in FIG. 1 the two shoulder belts 29 are provided one-piece with the two chest connection belts 27, in FIGS. 2 and 3 the two shoulder belts 29 and the two chest connection belts 27 are provided separate.

Depicted or described connections between components are generally to be understood to be functional connections. They can be implemented as direct links or as indirect links via several other components. The order of presented actions is not mandatory; alternative orders are possible. It is to be understood that the described embodiments are examples only, which may be modified and/or supplemented in many ways within the scope of the claims. In particular, any feature described for a particular embodiment can be used by itself or in combination with other features in any other embodiment. Each feature that has been described for an embodiment of a particular category can also be used in an equivalent manner in an embodiment of any other category.

REFERENCE NUMERALS

| | |
|---|---|
| belt loop | 1 |
| webbing | 2 |
| ribbon | 3 |
| first chest loop end | 4 |
| second chest loop end | 5 |
| belt loop connection area | 7 |
| chest loop connection buckle | 9 |
| belt connection loop | 10 |
| chest loop connector | 11 |
| chest loop | 13 |
| first chest loop connection end | 16 |
| second chest loop connection end | 17 |
| belay connection element | 22 |
| chest loop connection element | 23 |
| alamari | 24 |
| eyelet | 25 |
| chest connection belt | 27 |
| leg loop | 28 |
| shoulder belt | 29 |

1. A harness comprising a belt loop, a chest loop, at least one chest loop connection element, at least one chest connection belt, each having a first chest loop connection end and an opposite second chest loop connection end, and a belay connection element, wherein:
the belt loop and the chest loop are connected to one another via the belay connection element,
each first chest loop connection end and the chest loop are connected to one another, and
the belt loop and the belay connection element are configured for alternatively and detachably connecting with the respective second chest loop connection end via the respective at least one chest loop connection element.

2. The harness according to claim 1, wherein the at least one chest loop connection element is provided as at least one of buckles, as hooks, as knots and as carabiner with respective eyelets.

3. The harness according to claim 1, wherein the at least one chest loop connection element is provided as side release buckle or as alamari.

4. The harness according to claim 1, wherein the at least one chest loop connection element comprises an eyelet attached to the belt loop and to the belay connection element for connecting with the respective second chest loop connection end.

5. The harness according to claim 1, wherein the respective first chest loop connection end is connected to a backside of the chest loop and the belay connection element is connected to an opposite frontside of the chest loop.

6. The harness according to claim 1, wherein the belay connection element is connected to a front side of the belt loop and the belt loop is configured for being connected on an opposite back side via the respective at least one chest loop connection element.

7. The harness according to claim 1, wherein two first chest loop connection ends are distantly connected from the chest loop.

8. The harness according to claim 1, comprising two shoulder belts.

9. The harness according to claim 8, wherein the two shoulder belts are distantly connected with respective opposite ends to a backside and a frontside of the chest loop.

10. The harness according to claim 8, wherein each shoulder belt is provided as one-piece with one of the at least one chest connection belt.

11. The harness according to claim 1, wherein the belt loop comprises a belt loop connection area for connecting the belay connection element.

12. The harness according to claim 11, wherein the belt loop connection area is provided as belt connection loop connecting the belay connection element.

13. The harness according to claim 1, wherein the chest loop comprises a first chest loop end, an opposite second chest loop end and a chest loop connector for detachably connecting the first chest loop end and the second chest loop end.

14. The harness according to claim 3, wherein the chest loop connector is provided as chest loop connection buckle or as sliding chest loop buckle.

15. The harness according to claim 1, wherein at least one of the belt loop, the at least one chest connection belt, the belay connection element and the chest loop are provided as flat webbing.

16. The harness according to claim 1, comprising two leg loops.

17. The harness according to claim 16, wherein the two leg loops are distantly connected to the belay connection element.

18. A method for putting on a harness comprising a belt loop, a chest loop, at least one chest loop connection element, at least one chest connection belt, each having a first chest loop connection end and an opposite second chest loop connection end, and a belay connection element, wherein:
each first chest loop connection end and the chest loop are connected to one another, and comprising the steps of:
connecting the belt loop and the chest loop via the belay connection element together, and
detachably connecting each second chest loop connection end via the respective at least one chest loop connection element alternatively to the belt loop or to the belay connection element.
